(19) United States
(12) Patent Application Publication
(10) Pub. No.: US 2025/0112207 A1
(43) Pub. Date: Apr. 3, 2025

(54) MULTI-DIE CHIPLET-BASED APPLICATION SPECIFIC INTEGRATED CIRCUIT

(71) Applicant: Block, Inc., Oakland, CA (US)

(72) Inventors: Vikram Suresh, Portland, OR (US); Yue Yang, Toronto (CA)

(21) Appl. No.: 18/375,138

(22) Filed: Sep. 29, 2023

(51) Int. Cl. H01L 25/065; H01L 23/00; H01L 23/498; H01L 23/538

(52) U.S. Cl. CPC H01L 25/0655; H01L 23/49822; H01L 23/5383; H01L 24/08; H01L 24/16; H01L 25/0652; H01L 2224/08146; H01L 2224/16146; H01L 2224/16235; H01L 2924/1433

(57) ABSTRACT

Systems and methods for distributed ledger interactions, for instance for mining cryptocurriencie(s), are disclosed. In some examples, an Application Specific Integrated Circuit (ASIC) for mining cryptocurrency includes a plurality of hash dies arranged to perform application-specific processing. The ASIC includes a control die arranged to control the plurality of hash dies. The control die is formed using a larger node than the plurality of hash dies. The ASIC includes one or more interconnectors electrically connecting the control die to the one or more hash dies. The ASIC includes an integrated circuit package enclosing the control die and the one or more hash dies.

### TECHNICAL FIELD

Application specific integrated circuits (ASICs) are integrated circuits that are customized for a particular use, rather than general use. ASICs are commonly used in Proof of Work (PoW) based cryptocurrency mining, such as the mining of Bitcoin. Traditionally, mining ASICs are single-die integrated circuits (ICs) comprising a hash core, arranged to perform processing for solving mining algorithms, and control logic arranged to control the hash core.

### BRIEF DESCRIPTION OF THE DRAWINGS

Features of the present disclosure, its nature and various advantages, will be more apparent upon consideration of the following detailed description, taken in conjunction with the accompanying drawings, which is set out below. In the drawings, the use of the same reference numbers in different drawings indicates similar or identical items. The systems depicted in the accompanying drawings are not to scale and components within the drawings may be depicted not to scale with each other.

FIG. 1 illustrates an example ASIC architecture, in accordance with some examples.

FIG. 2 illustrates an example mining ASIC, in accordance with some examples.

FIG. 3 provides a cross-sectional perspective of the example ASIC architecture of FIG. 1, in accordance with some examples.

FIG. 4 illustrates an example ASIC stack forming an example mining rig, in accordance with some examples.

FIG. 5 illustrates an example ASIC stack utilizing the example ASIC architecture shown in FIG. 1 and FIG. 3, in accordance with some examples, in accordance with some examples.

FIG. 6 illustrates an ASIC chiplet arrangement that uses microbump connections, in accordance with some examples.

FIG. 7 illustrates an ASIC chiplet arrangement that uses hybrid bond connections, in accordance with some examples.

FIG. 8 is flow diagram illustrating a process for application-specific processing, in accordance with some examples.

FIG. 9 depicts a block diagram illustrating an example system for performing techniques described herein, in accordance with some examples.

### DETAILED DESCRIPTION

Mining cryptocurrency, i.e. blockchain-based digital currencies, using a Proof Of Work (PoW) consensus model involves a competitive process to solve complex mathematical problems. Operators of powerful computing systems, called miners, compete against one another to solve a complex mathematical problem to determine the hash of a next block in the blockchain. The miner that solves the problem is rewarded with new cryptocurrency. In turn, the process, which requires a certain amount of computational power to solve the complex mathematical problem, prevents anybody gaming the system and provides security to this open and decentralized form of digital currency such that it does not require a central governing authority.

Given the reward of solving the complex mathematical problem to obtain the next hash, many miners look to improve the computational performance of their processors. Given mining is usually done using ASICs, due to the performance/cost benefit of such application specific processors, this means that computational speed of ASICs continues to increase.

ASICs are integrated circuits (ICs) including a plurality of hash cores that are controlled by control logic. An intellectual property core (IP core) is a functional block of logic or data used to make an ASIC or a field-programmable gate array (FPGA). Such mining ASICs are commonly fabricated as a monolithic design made of hash cores, control logic and other hard IP cores and soft IP cores, all implemented on the same die or IC. IP cores are the intellectual property associated with the layout design of the semiconductor arranged to provide certain functionality (e.g., the chip design). Hard IP cores (sometimes referred to as hard IPs) are specific layout designs that generally are not (and sometimes cannot) be changed or edited, for instance representing a physical manifestation of a specifically designed layout. In contrast, Soft IP cores (sometimes referred to as soft IPs) are customisable blocks of semiconductor layout design. In some examples, soft IP cores can be configured and modified for different applications, can be moved around an ASIC and/or coupled to and/or connected to different components of the ASIC. In some examples, soft IP cores can include a modifiable netlist (e.g., a list of the logic gates and associated interconnections making up the IC).

Semiconductor ICs are continually being fabricated with ever smaller node sizes. For example, in 2012 the smallest technology node commercially available had a node size of 22 nm, whereas by 2022, the smallest node size was down to 3 nm. This decreasing technology node size enables increased processing speeds and power within the same die size. However, it takes time to redevelop ASICs to capitalize on the latest advances in semiconductor technology. That said, any way in which an ASIC could be developed with the latest in semiconductor functionality faster may be advantageous to the cryptocurrency mining industry, as well as other industries using ASICs. However, there are problems with designing, developing, testing and bringing the latest technology to the ASICs market. These problems are solved herein by reconfiguring the underlying architecture of the ASIC.

The hash cores, which perform the complex mathematical processing and therefore define the mining performance and energy efficiency, may necessitate ultra-low voltage operation in advanced process nodes. Typically, hash cores operate on a 600 MHz clock at near threshold voltage of ˜300 mV. In contrast, the supporting control logic, phased-locked loop (PLL) for generating the high-speed clock, and voltage/thermal sensors for monitoring the ASIC performance may operate at a more traditional voltage of 0.75V, using a slow frequency clock in the range of 25 MHz. The control logic, PLL and sensors may not require advanced process nodes for high performance or ultra-low voltage operation. However, in traditional ASIC architectures having a monolithic construction (i.e. where all ASIC functionality is implemented within at least one semiconductor wafer), the soft-IPs of the control logic may still need to be reimplemented and verified on each new process node, which considerably impacts design time and cost. Further, silicon proven hard IPs such as PLL and sensors, need to be procured from reliable third party vendors, requiring further development, testing and validation of IPs on the new process node. While the hash core, which is the most critical block on the ASIC, may be a pure digital logic without any memory macros or analog circuits, PLLs and sensors are often analog IPs which take longer to mature in a new process. It has been recognised by the inventor(s) that the characteristics of the control logic, PLL and sensors, which don't benefit from the advances in reduced node size, affect the agility of mining ASICs from moving to advanced process technologies and time to market.

In order to provide a structure that is more flexible in relation to use of third party IPs and to make ASIC design more agile to process migration, a chiplet architecture may utilize 2.5D and 3D packaging technologies such that the hash cores are manufactured in the latest technology node, while the control logic and IPs may be fabricated on an older mature technology. For example, the hash cores may be fabricated on 3 nm nodes, or better, while the control logic and IPs may be fabricated on 10 nm node semiconductor, or even more mature nodes such as 28 nm or 45 nm. The control logic and IPs which may be fabricated on one die and the hash cores which may be fabricated on one or more further dies that can be joined into a single integrated circuit application (ICA). One way in which this can be achieved is by at least one Control Die (CD) being integrated with multiple Hash Die (HD) on a silicon interposer. Signals and clocks may be coupled (e.g., connected) through microbumps and routed using a redistribution layer.

Other connections used in 2.5D and 3D chiplet architecture such as bump-less hybrid bonding techniques may be used. Through Silicon Vias (TSV) may be used to provide signal, clock and power/ground connectivity to the CD and power/ground connectivity to the HD. For instancy, a TSV can pass through the depth of a circuit board (e.g., a planar circuit board), such as a control die or interposer, from a first point on a first surface of the circuit board to a second point on a second surface of the circuit board. A common PLL on the CD provides one or more high speed clocks to the HDs. It will be appreciated that the clock and data signals within each HD may be received at a single point and then distributed throughout the HD. Alternatively, the clock and data signals may be delivered to each has core in a HD, for example via specific data connections per hash core. Voltage and thermal sensing may be implemented by incorporating sensors (probe points) on the HD, with the measurement logic implemented on the CD. A process sensor or monitor may also be used, wherein the process sensor may detect how much process variation we are seeing on each die.

This chiplet architecture has numerous technical advantages. Since the hash cores, which may use purely digital logic, are fabricated in the advanced node, this architecture enables faster migration to advanced nodes. Furthermore, since the hash cores are fabricated in the advanced node, faster migration to different foundries is possible, and/or enables use of a mix of hash dies from different foundries. Given the HDs are fabricated as stand-alone die, rather than integrated with various control functionality, they are more yield tolerant, with fewer potential points of failure. In addition, by fabricating the ASIC by coupling (e.g., connecting) the HD with a single CD, the CD can be used across multiple generations of products, without the need to reimplement the control logic or source new third party IPs. This chiplet architecture also provides modularity, enabling different skews depending on the hash rate target per ASIC. In addition, hash cores on advanced nodes can be fabricated with fewer Vt flavors, which in turn means potential savings in mask and wafer cost. For example, Vt is the threshold voltage which determines the voltage at which the transistor turns on. There are a range of transistors with differing threshold voltages available in each node. However, using a variety of different Vt flavors, i.e. transistors with differing threshold voltages, require use of multiple masks and increases cost. Hence, limiting the Vt flavors can help reduce cost and improve yield. Since a single CD is shared among multiple HDs, this may reduce the number of ASIC connections on the board, thus increasing reliability.

Another advantage of having a single CD shared among multiple HDs is that system features beneficial for voltage stack stabilization and fast power-on are integrated onto the CD, which can reduce the complexity and increase the reliability of each HD. Designing the CD in an older technology makes it more suitable to integrate analog circuitry for voltage stack balancing on the CD, that may be currently implemented on the PCB using discrete components. Furthermore, such established CD technologies can provide higher compute density and more reliable clock distribution and voltage/thermal sensing. In addition, the fact that the CD can be implemented on more established technology nodes means that they can be cheaper to implement, as they don't require the latest and most expensive semiconductor technology. By enabling new HD to be developed and integrated with a reliable CD, a platform is provided for open source approaches to hash engine development. For example, experimentation with advanced circuit/device technologies such as using novel devices, in-memory compute and silicon photonics could be utilised on the HD.

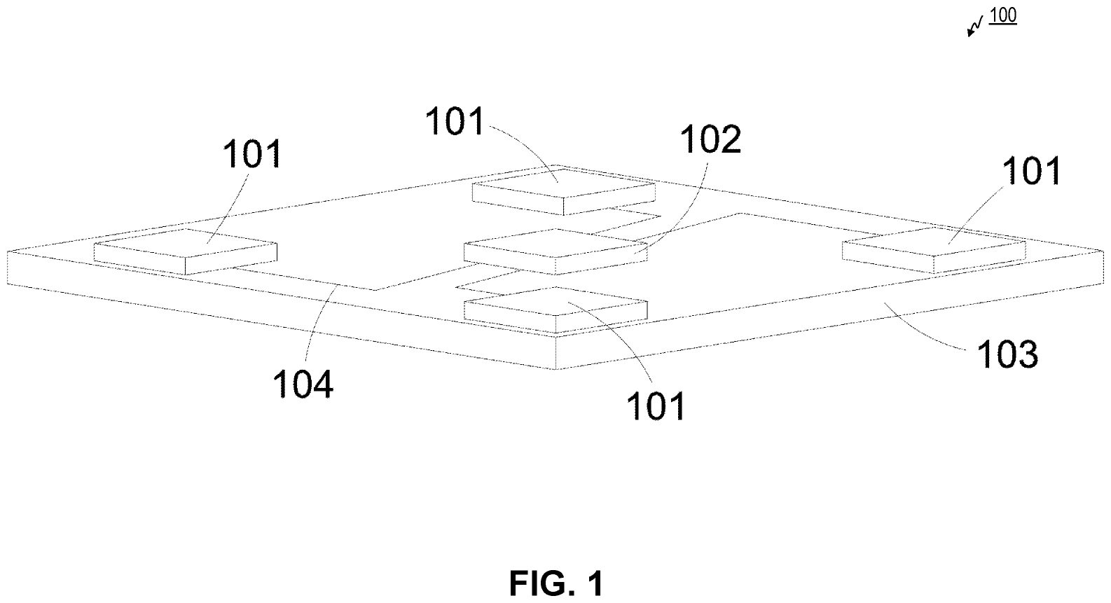

The chiplet architecture, or ASIC architecture, will now be discussed with reference to FIG. 1, which provides an illustrative perspective view of an example chiplet architecture 100. The new chiplet architecture 100 includes four HDs 101. Each HD 101 may include numerous hash cores. While four HDs are shown in FIG. 1, it will be appreciated that this is only an illustration. Four to six HDs per CD may be preferable. However, any number of HDs may be included within a single chiplet. The chiplet architecture 100 also includes a CD 102, which is coupled to (e.g., connected to) each HD 101 via an interposer 103. The interposer provides connections 104 for control signals and clock signals to communicated between the CD and HDs on the chiplet (associated with the chiplet architecture 100).

The CD 102 incorporates control logic, PLL for the chiplet, and performance sensing (such as thermal and voltage sensing). Voltage and thermal sensing is implemented by incorporating sensors (probe points) on the HD 101, with the measurement logic implemented on the CD 102. In this way, in some implementations only the absolute requirements of the sensing parts are integrated within the HD, which simplifies the development of the HD and reduces risk of errors. The CD can then continue to incorporate the established sensing measurement logic, simply arranged to receive sensing signals from the sensing parts integrated within the HDs.

The CD 102 is fabricated using an established technology node. At the same time, the HDs 101 can be fabricated using the latest technology nodes, or a preferred technology node for the application or desired functionality. Hence, the CD may be made of a semiconductor material having a larger node size in nm, compared to the HDs. This approach means that the same CD can be used alongside differing, and likely more advanced, HDs. In addition, this can reduce the complexity of bringing a new product to market while also improving aspects of performance and reliability as discussed previously.

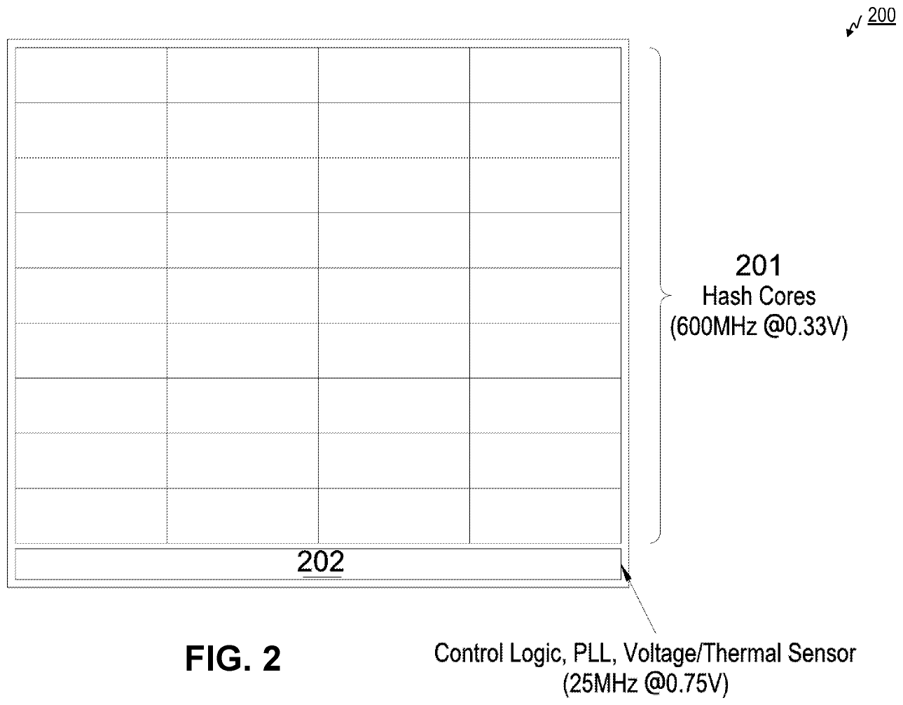

In contrast, FIG. 2 illustrates a mining ASIC 200 in which numerous hash cores 201, and other component(s) and/or functionality 202 including the control logic, PLL and voltage/thermal sensors, are integrated within a single technology node. It can be seen that in order to improve any aspect of the mining ASIC 200, the whole ASIC has to be redeveloped and worked onto the highest performing technology node for the ASIC as a whole. Not only is this approach slow, but it also means that an expensive and complex top-end technology node is being used to implement standard functionality provided by components such as the control logic.

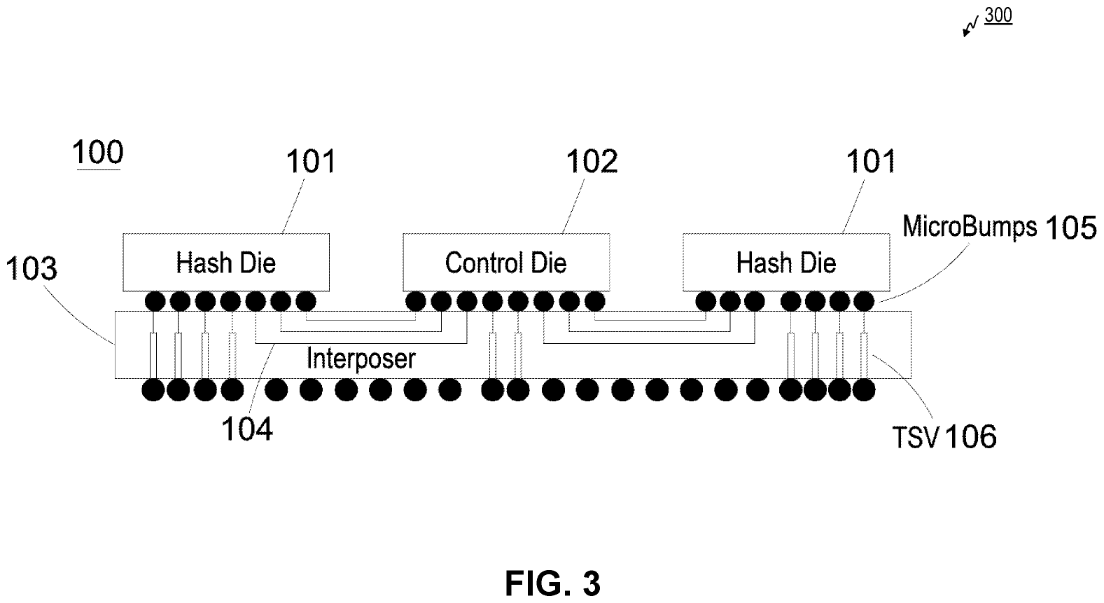

FIG. 3 provides a cross-sectional perspective 300 of the chiplet architecture 100 of FIG. 1. It can be seen how the HDs 101 and CD 102 are coupled to (e.g., connected to) the interposer via microbumps 105. Connections to the chiplet for other signal, clock and power/ground connectivity are provided via Through Silicon Vias (TSVs) 106. It will be appreciated that the relative position of the components in FIG. 3, and all other figures, is illustrative only.

In FIG. 1 and FIG. 3, it can be seen that the interposer 103 acts as a substrate. The HDs 101 may be mounted on the interposer 103, and the CD may be mounted on the interposer. Hence, the chiplet (associated with the chiplet architecture 100) may be a layered structure with the interposer 103 forming a first layer and the HDs 101 and the CD 102 forming a second layer. In such an arrangement, the HDs 101 and the CD 102 may be positioned on a single plane.

The microbumps 105 act as connections. In particular, the microbumps 105 provide electrical and communicative coupling between the HDs 101/CD 102 and the interposer 103. The microbumps 105 may also provide a structural coupling (e.g., structural connection) between the HDs 101/CD 102 and the interposer 103.

The interposer 103 may have electrical connections built-in which couple (e.g., directly connect) inputs and/or outputs of the HDs 101 with input and/or outputs of the CD 102. The electrical connections within the interposer 103 lead directly to microbumps 105 for coupling to (e.g., connection to) the HDs 101 and the CD 102. The internal electrical connections on the interposer 103 may be fabricated on a first surface of the interposer 103, shown as the upper surface in FIG. 3. As such, the HDs 101 and CD 102 may be mounted on the first surface of the interposer. However, in other arrangements, one or more of the HDs and CD may be mounted on the first surface of the interposer 103, while other one or more of the HDs and CD may be mounted a second surface of the interposer, e.g. the lower surface. In such arrangements, the electrical connections in the interposer 103 may traverse through the interposer 103.

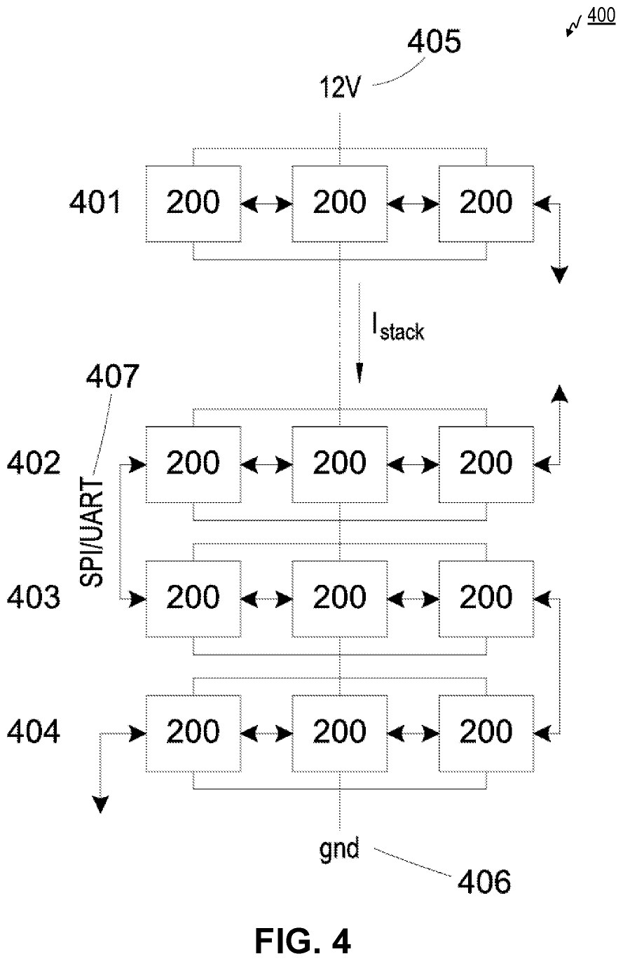

In FIG. 3, TSVs 106 provide electrical coupling (e.g., electrical connections) through the interposer 103. Each of the TSVs 106 can pass through a depth of the interposer 103, from a first point along a first surface of the interposer 103 to a second point along a second surface of the interposer 103. As such, one or more of the HDs and CD mounted on the first surface of the interposer, the upper surface in FIG. 3, can have electrical connections on the second surface of interposer 103, the lower surface in FIG. 3. These electrical connections on the lower surface of the interposer 103 allow for easy coupling to (e.g., connection to) external components or external devices. For example, coupling to (e.g., connections to) an external clock (e.g. the PLL itself needs a slower speed clock, usually ˜25 MHz, that comes from a crystal oscillator on the board, outside of the ASIC) and power/ground may be provided through these connections provided via the TSVs. This allows integration and/or synchronization with other ASICs. These external coupling (e.g., external connections) may also provide coupling to (e.g., connectivity to) neighboring ASICs, as illustrated in FIGS. 4-7. Other forms of external coupling (e.g., external connections) for signal, clock, and/or power connectivity may be provided. For example, couplings (e.g., connections) could be provided on the first surface of the interposer, i.e. the same surface on which the HDs and CD are mounted.

FIG. 4 shows a ASIC stack 400 forming a mining rig. The ASIC stack 400 includes a plurality of ASICs 200 as illustrated in FIG. 2. The stack 400 includes layers 401-404 of ASICs 200, grouped in three ASICs per layer. The layers include, for instance, a layer 401, a layer 402, a layer 403, and a layer 404. Each layer of three ASICs (i.e. a subgroup) are powered in parallel, with each layer stacked in series between the voltage terminal 405 and the voltage terminal 406. The electrical power connectivity is illustrated with solid line couplings (e.g., connections) between the ASICs. However, the layers of the stack 400 are not shown and therefore a dashed line is shown where the additional layers are left out. The current flowing through the stack is referred to as I_{stack}. Each ASIC may be communicatively coupled (e.g., communicatively connected) in series via an interconnection protocol such as SPI or UART, as shown by dashed connection lines 407. It is through the daisy chained serial link that the hash board is able to host hundreds of ASICs without requiring a dedicated coupling (e.g., a dedicated connection) to each ASIC from the host controller. All ASICs on the board are able to work together in parallel to solve the complex mathematical problem involved in the proof of work. It will be appreciated that the number of layers in the stack and the number of ASICs per layer may vary depending on the requirements and/or design of the stack.

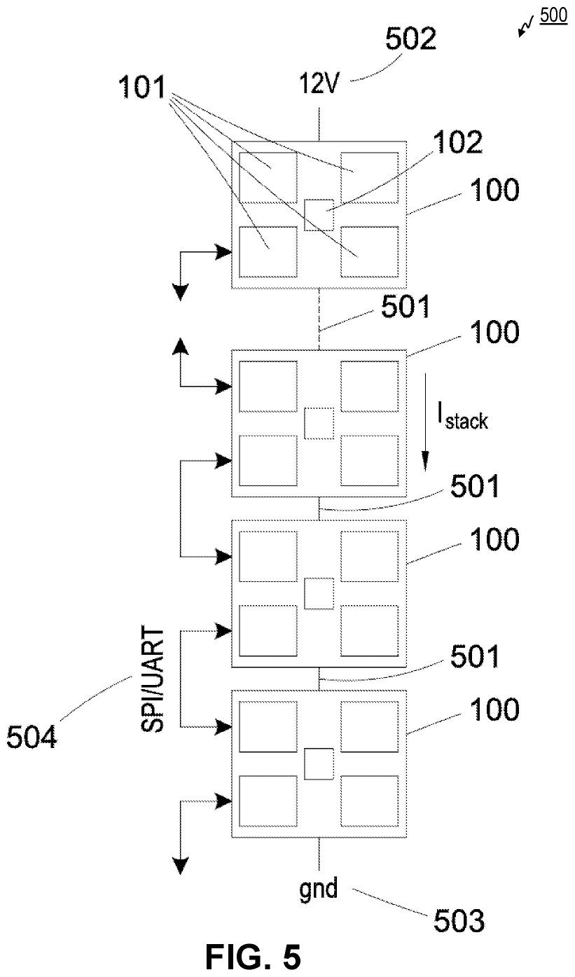

FIG. 5 shows an ASIC stack 500 utilizing the novel ASIC architecture shown in FIG. 1 and FIG. 3. In the stack of FIG. 5, each layer of the stack includes a single ASIC (associated with the chiplet architecture 100) (i.e. each ASIC is equivalent to the subgroup of FIG. 4, but integrated within a single ASIC), each includes a single CD and multiple HDs. In such implementations, power couplings (e.g., power connections) can be only needed between each ASIC, as shown by the power connectors 501. The ASICS are arranged in series between the power terminals 502, 503. The HDs within a single ASIC are already communicatively interconnected, and therefore communication connections 504, shown as SPI or UART in this example, may be provided between ASICs. Hence, the fact that the ASIC (associated with the chiplet architecture 100) incorporates multiple HDs into a single chiplet, meaning that fewer power and communication connections are provided within the overall mining stack. This helps to reduce complexity, errors, and cost (e.g., of hashing computations, mining, and/or other computations), while improving reliability and performance (e.g., of hashing computations, mining, and/or other computations).

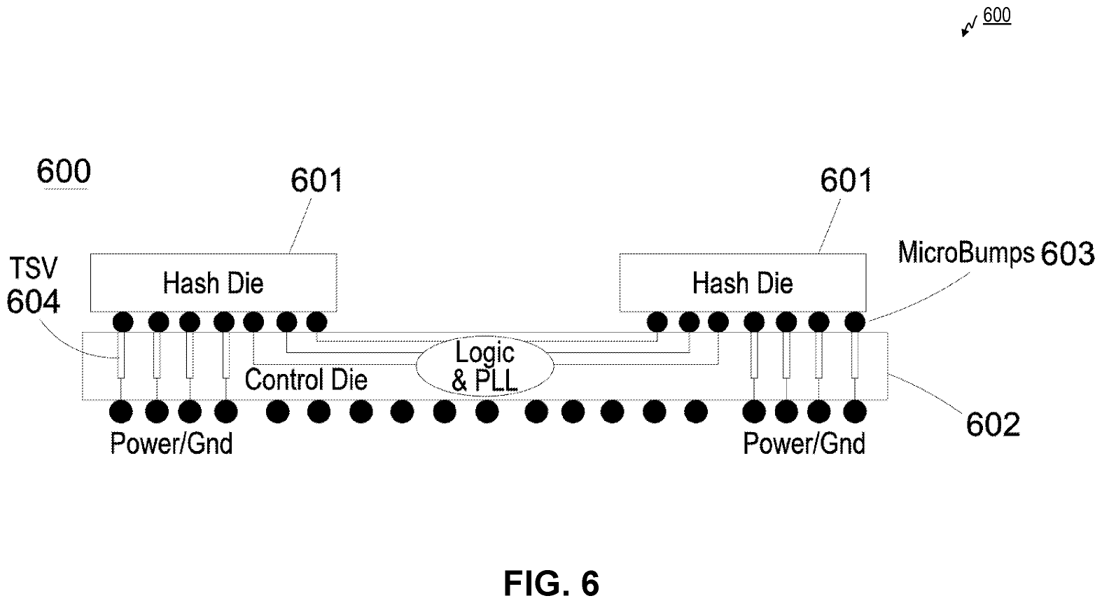

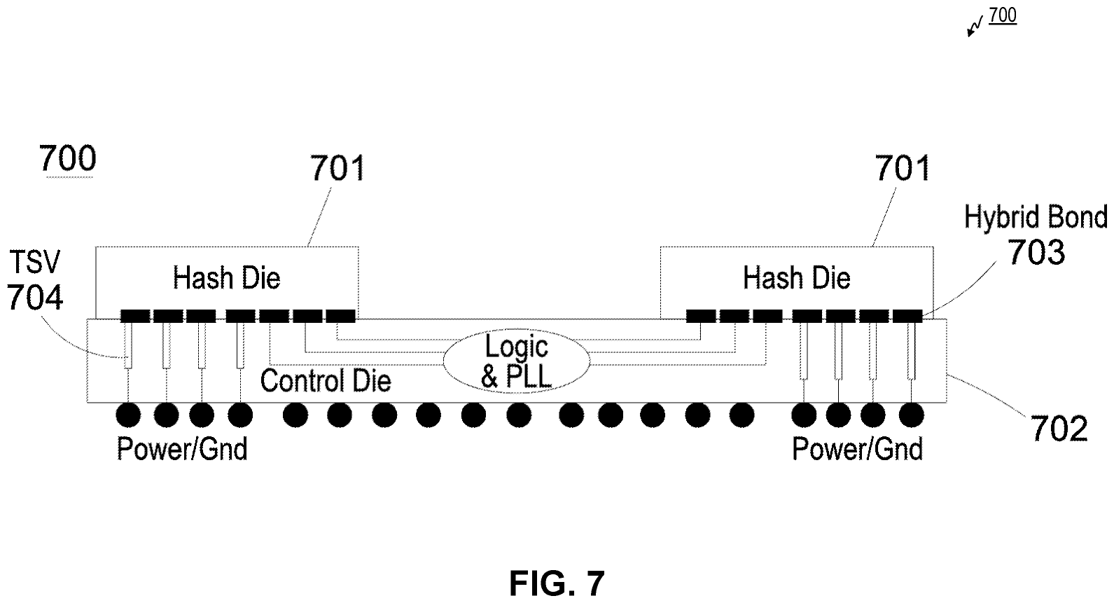

FIG. 6 illustrates an ASIC chiplet arrangement that uses microbump connections 603. FIG. 7 illustrates an ASIC chiplet arrangement that uses hybrid bond connections 703.

In FIG. 6, the chiplet 600 is arranged with the HDs 601 directly mounted onto the CD 602 via microbump connections 603. This may be achieved using chip-on-chip, chip-on-wafer or wafer-on-wafer packaging technologies. The control logic and PLL functionality is incorporated within the CD. Through Silicon Vias (TSVs) 604 formed within the CD provide power and ground connections to the HDs 601 through the CD 602. Each of the TSVs 604 can pass through a depth of the CD 602, from a first point along a first surface of the CD 602 to a second point along a second surface of the CD 602. FIG. 7 provides a chiplet 700 wherein the HDs 701 are coupled to (e.g., connected directly to) the CD 702 via a hybrid bond connection 703. Again TSVs 704 formed within the CD provide power and ground connections to the HDs 701 through the CD 702. Each of the TSVs 704 can pass through a depth of the CD 702, from a first point along a first surface of the CD 702 to a second point along a second surface of the CD 702.

In these arrangements, the HDs are formed on the CD. The wafers of the HDs and CD are therefore arranged in parallel. The HDs are arranged in the same plane. The HDs and the CD are then bonded together via microbumps, hybrid bonds or another suitable method. The bond therefore provides communicative coupling as well as a physical coupling (e.g., physical connection). Hence, the CD replaces the need for an interposer. As such, the number of connections is reduced, which simplifies the fabrication process, reduces production costs (due to a simpler process and less material), and reduces potential fault issues. In the case of 3D stacking, signal, and/or clock couplings (e.g., connections) from CD to HD can be made once per HD and distributed locally on the HD or they may be delivered directly to each hashing core in the HD. It will be appreciated that both wafers may be arranged in parallel with one another (wafer-on-wafer), or a HD die and CD wafer may be in parallel (chip on wafer), or HD and CD dies may be in parallel (die on die).

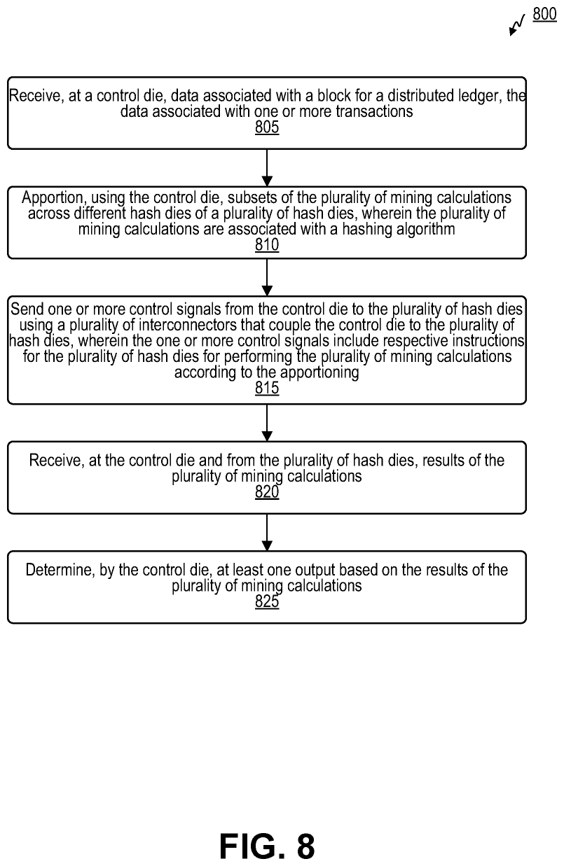

FIG. 8 is flow diagram illustrating a process 800 for application-specific processing, in accordance with some examples. In some examples, the process 800 is performed by an application-specific processing system. The application-specific processing system can include, for instance, the chiplet architecture 100 (e.g., as illustrated in any of FIGS. 1, 3, 4, 5, and/or 9), one or more HDs 101, the CD 102, the interposer 103, the connections 104, the microbumps 105, the TSVs 106, the ASIC 200 (e.g., as illustrated in any of FIG. 2 or 4), the hash cores 201, the other component(s) and/or functionality 202, the ASIC stack 400, the layer 401, the layer 402, the layer 403, the layer 404, the voltage terminal 405, the voltage terminal 406, the connection(s) illustrated by the dashed connection lines 407, the ASIC stack 500, the power connectors 501, the power terminals 502, the power terminals 503, the communication connections 504, the chiplet 600, the HDs 601, the CD 602, the microbump connections 603, the TSVs 604, the chiplet 700, the HDs 701, the CD 702, the microbump connections 703, the TSVs 704, the system 900, the mining stack 901, the network(s) 910, the user device 920, the processor(s) 921, the computer-readable media 922, the user interface 927, the other components and data 928, the operating system 929, the communication interface(s) 923, the input/output devices 924, the display 925, the sensor(s) 926, the sever(s) and/or datastore(s) 930, the reader device 940, a computing system, an apparatus, a processor executing instructions stored in a non-transitory computer-readable storage medium, an ASIC, an FPGA, a chiplet, a hashboard, a sensor probe, a sensor, one or more components or subsets of any of the previously-listed systems, or a combination thereof. The order in which the operations of the process 800 are described is not intended to be construed as a limitation, and any number of the described blocks can be combined in any order and/or in parallel to implement the processes. In some embodiments, one or more blocks of the process 800 can be omitted entirely. Moreover, the process 800 can be combined in whole or in part with other processes, methods, actions, and/or operations described herein.

At operation 805, the application-specific processing system (or at least one component or subsystem thereof) is configured to, and can, receive, at a control die (e.g., the CD 102, the CD 602, the CD 702), data associated with a block for a distributed ledger (e.g., a blockchain ledger). The data is associated with one or more transactions (e.g., to be included in a payload of the block).

At operation 810, the application-specific processing system (or at least one component or subsystem thereof) is configured to, and can, apportion, using the control die, subsets of the plurality of mining calculations across different hash dies of a plurality of hash dies (e.g., the one or more HDs 101, the HDs 601, the HDs 701). The plurality of mining calculations are associated with a hashing algorithm, such as a secure hashing algorithm (SHA) (e.g., SHA-256, SHA-512, SHA-2, SHA-3).

At operation 815, the application-specific processing system (or at least one component or subsystem thereof) is configured to, and can, send one or more control signals from the control die to the plurality of hash dies using a plurality of interconnectors that couple the control die to the plurality of hash dies. The one or more control signals include respective instructions for the plurality of hash dies for performing the plurality of mining calculations according to the apportioning (e.g., the apportioning of operation 810).

At operation 820, the application-specific processing system (or at least one component or subsystem thereof) is configured to, and can, receive, at the control die and from the plurality of hash dies, results of the plurality of mining calculations. In some examples, the results of the plurality of mining calculations can include various hashes calculated by the plurality of hash dies.

At operation 825, the application-specific processing system (or at least one component or subsystem thereof) is configured to, and can, determine, by the control die, at least one output based on the results of the plurality of mining calculations. The at least one output can be, for instance, a hash that meets the requirements of a proof-of-work (PoW) consensus mechanism or some other consensus mechanism (e.g., a target hash). For instance, in some examples, in a PoW consensus mechanism, mining involves selecting nonce values to include with the data being hashed (e.g., the data of operation 805) that causes the resulting hash to be lower than (or greater than) a target value. The target value may be determined based on a difficulty value associated with the distributed ledger and/or the block, and/or may be based on previous blocks.

In some examples, the control die can apportion (e.g., at operation 810) different hash dies to generate hashes for different ranges of nonces, so that the mining computations can be parallelized across hash dies, increasing efficiency of mining computations. The control die can select the at least one output (e.g., the at least one hash) from among the different hashes generated by the different hash dies based on which of the different hashes meets the requirements of the consensus mechanism (e.g., is less than or greater than the target value). In some examples, the control die can apportion (e.g., at operation 810) different hash dies to generate hashes for different sets of data altogether (e.g., associated with different transaction(s) and/or different blocks), so that the mining computations can be parallelized across hash dies, increasing efficiency of mining computations.

In some examples, the control die can identify characteristic(s) of the hash dies using sensor data received from one or more sensors that are arranged to monitor the hash dies. The characteristic(s) can include, for instance, temperature, voltage, current, resistance, impedance, power usage, changes in any of the previously-listed characteristics over time, or a combination thereof. In some examples, the control die can apportion the plurality of mining calculations (e.g., at operation 810) according to the monitored characterisitic(s) of the hash dies. For instance, if a particular hash die has a temperature (or some other characteristic(s)) that exceeds a threshold associated with risk, the control die can send less of the mining calculations to that particular hash die than to other hash dies, and/or can send less of the mining calculations to that particular hash die than the control die has previously sent to that particular hash die.

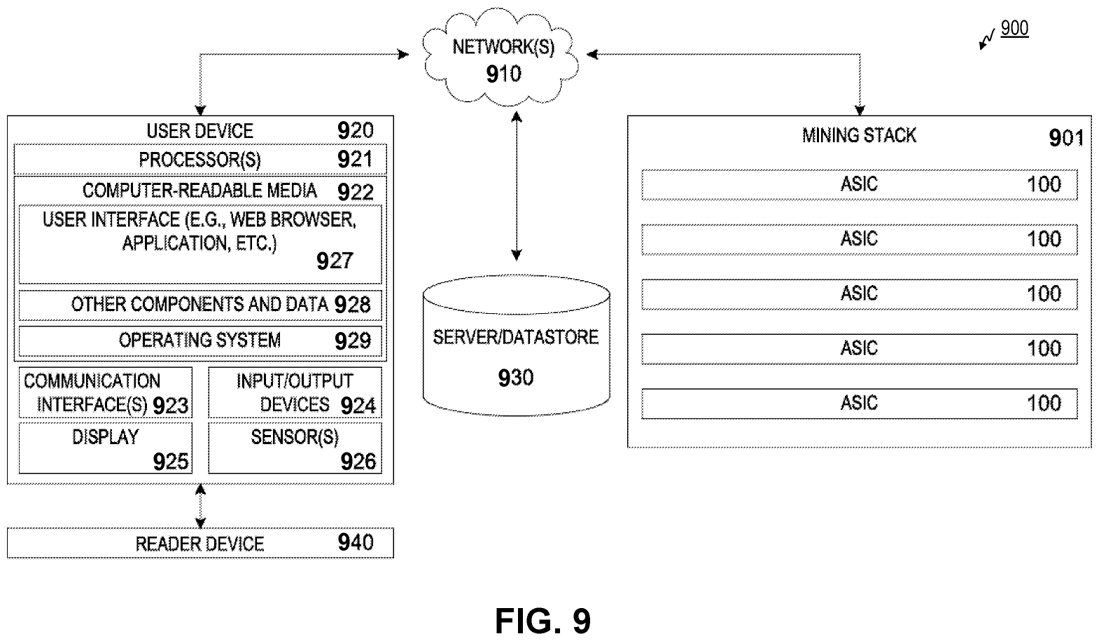

FIG. 9 depicts a block diagram illustrating a system 900 for performing techniques described herein. In particular, FIG. 9 shows how a mining stack 901 including a plurality of ASICs (associated with the chiplet architecture 100) according to previous Figures may communicate, via one or more network(s) 910, with a user device 920, and server(s) and/or datastore(s) 930. The system 900 includes the user device 920, that communicates with server computing device(s) (e.g., server(s) and/or datastore(s) 930) via network(s) 910 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 920 is illustrated, in additional or alternate examples, the system 900 can have multiple user devices. The system 900 also includes the mining stack 901, which performs the application-specific processing (e.g. cryptocurrency mining).

In at least one example, the user device 920 can be any suitable type of computing device, e.g., portable, semi-portable, semi-stationary, or stationary. Some examples of the user device 920 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. That is, the user device 920 can be any computing device capable of sending communications and performing the functions according to the techniques described herein. The user device 920 can include devices, e.g., payment card readers, or components capable of accepting payments, as described below.

In the illustrated example, the user device 920 includes one or more processors 921, one or more computer-readable media 922, one or more communication interface(s) 923, one or more input/output (I/O) devices 924, a display 925, and sensor(s) 926.

In at least one example, each processor 921 can itself comprise one or more processors or processing cores. For example, the processor(s) 921 can be implemented as one or more microprocessors, microcomputers, microcontrollers, digital signal processors, central processing units, state machines, logic circuitries, and/or any devices that manipulate signals based on operational instructions. In some examples, the processor(s) 921 can be one or more hardware processors and/or logic circuits of any suitable type specifically programmed or configured to execute the algorithms and processes described herein. The processor(s) 921 can be configured to fetch and execute computer-readable processor-executable instructions stored in the computer-readable media 922.

Depending on the configuration of the user device 920, the computer-readable media 922 can be an example of tangible non-transitory, or transitory, computer storage media and can include volatile and non-volatile memory and/or removable and non-removable media implemented in any type of technology for storage of information such as computer-readable processor-executable instructions, data structures, program components or other data. The computer-readable media 922 can include, but is not limited to, RAM, ROM, EEPROM, flash memory, solid-state storage, magnetic disk storage, optical storage, and/or other computer-readable media technology. Further, in some examples, the user device 920 can access external storage, such as RAID storage systems, storage arrays, network attached storage, storage area networks, cloud storage, or any other medium that can be used to store information and that can be accessed by the processor(s) 921 directly or through another computing device or network. Accordingly, the computer-readable media 922 can be computer storage media able to store instructions, components or components that can be executed by the processor(s) 921. Further, when mentioned, non-transitory computer-readable media exclude media such as energy, carrier signals, electromagnetic waves, and signals per se.

The computer-readable media 922 can be used to store and maintain any number of functional components that are executable by the processor(s) 921. In some implementations, these functional components comprise instructions or programs that are executable by the processor(s) 921 and that, when executed, implement operational logic for performing the actions and services attributed above to the user device 920. Functional components stored in the computer-readable media 922 can include a user interface 927 to enable users to interact with the user device 920, and thus the server(s) and/or datastore(s) 930 and/or other networked devices, e.g. the mining stack 901. In at least one example, the user interface 927 can be presented via a web browser, or the like. In other examples, the user interface 927 can be presented via an application, such as a mobile application or desktop application, which can be provided by a service provider associated with the server(s) and/or datastore(s) 930 or other computing devices on the network, or which can be an otherwise dedicated application. In some examples, the user interface 927 can provide a means for a user to either directly control or monitor the processing at the mining stack 901. For example, the user interface 927 may enable a user to directly switch power off or on for specific application-specific processors or other aspects or functions of the mining stack 901. In other implementations, the user may have an account with multiple different stacks in the same or different locations that can be controlled via the app, either remotely or when on site. In at least one example, a user can interact with the user interface via touch input, spoken input, gesture, or any other type of input. The word “input” may also be used to describe “contextual” input that may not be directly provided by the user via the user interface 927. For example, user's interactions with the user interface 927 are analyzed using, e.g., natural language processing techniques, to determine context or intent of the user, which may be treated in a manner similar to “direct” user input.

Depending on the type of the user device 920, the computer-readable media 922 can also optionally include other functional components and data, such as other components and data 928, which can include programs, drivers, etc., and the data used or generated by the functional components. In addition, the computer-readable media 922 can also store data, data structures and the like, that are used by the functional components. Further, the user device 920 can include many other logical, programmatic and physical components, of which those described are merely examples that are related to the discussion herein.

In at least one example, the computer-readable media 922 can include additional functional components, such as an operating system 929 for controlling and managing various functions of the user device 920 and for enabling basic user interactions.

The communication interface(s) 923 can include one or more interfaces and hardware components for enabling communication with various other devices, such as over the network(s) 910 or directly. For example, communication interface(s) 923 can enable communication through one or more network(s) 910, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 910 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

In some implementations some of the functionality may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 920 can further include one or more input/output (I/O) devices 924. The I/O devices 924 can include speakers, a microphone, a camera, and various user controls (e.g., buttons, a joystick, a keyboard, a keypad, etc.), a haptic output device, and so forth. The I/O devices 924 can also include attachments that leverage the accessories (audio-jack, USB-C, Bluetooth, etc.) to couple with (e.g., connect with) the user device 920.

In at least one example, user device 920 can include a display 925. Depending on the type of computing device(s) used as the user device 920, the display 925 can employ any suitable display technology. For example, the display 925 can be a liquid crystal display, a plasma display, a light emitting diode display, an OLED (organic light-emitting diode) display, an electronic paper display, or any other suitable type of display able to present digital content thereon. In at least one example, the display 925 can be an augmented reality display, a virtually reality display, or any other display able to present and/or project digital content. In some examples, the display 925 can have a touch sensor associated with the display 925 to provide a touchscreen display configured to receive touch inputs for enabling interaction with a graphic interface presented on the display 925. Accordingly, implementations herein are not limited to any particular display technology. Alternatively, in some examples, the user device 920 may not include the display 925, and information can be presented by other means, such as aurally, haptically, etc.

In addition, the user device 920 can include sensor(s) 926. The sensor(s) 926 can include a GPS device able to indicate location information. Further, the sensor(s) 926 can include, but are not limited to, an accelerometer, gyroscope, compass, proximity sensor, camera, microphone, and/or a switch.

In some example, the GPS device can be used to identify a location of a user. In at least one example, the location of the user can be used by the service provider, described above, to provide one or more services. That is, in some examples, the service provider can implement geofencing to provide particular services to users. As an example, with a lending service, location can be used to confirm that a stated purpose of a loan corresponds to evidence of use (e.g., Is the user using the loan consistent with what he or she said he or she was going to use it for?). Furthermore, in some examples, location can be used for payroll purposes. As an example, if a contractor completes a project, the contractor can provide a geo-tagged image (e.g., tagged based on location information availed by the GPS device). In some examples, location can be used for facilitating peer-to-peer payments between nearby users and/or for sending users notifications regarding available appointments with merchant(s) located proximate to the users. In at least one example, location can be used for taking payments from nearby customers when they leave a geofence, or location can be used to initiate an action responsive to users enter a brick-and-mortar store of a merchant, or mining facility. Location can be used in additional or alternative ways as well.

Additionally, the user device 920 can include various other components that are not shown, examples of which include removable storage, a power source, such as a battery and power control unit, a barcode scanner, a printer, a cash drawer, and so forth.

In addition, in some examples, the user device 920 can include, be coupleable to (e.g., connectable to), or otherwise be coupled to a reader device 940, for reading payment instruments and/or identifiers associated with payment objects. In some examples, as described above, the reader device 940 can plug in to a port in the user device 920, such as a microphone port, a headphone port, an audio-jack, a data port, or other suitable port. In additional or alternative examples, the reader device 940 can be coupled to the user device 920 via another wired or wireless connection, such as via a Bluetooth®, BLE, and so on. The reader device 940 can include a read head for reading a magnetic strip of a payment card, and further can include encryption technology for encrypting the information read from the magnetic strip. Additionally or alternatively, the reader device 940 can be an EMV payment reader, which in some examples, can be embedded in the user device 920. Moreover, numerous other types of readers can be employed with the user device 920 herein, depending on the type and configuration of the user device 920.

The reader device 940 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data off any payment instrument. Accordingly, the reader device 940 may include hardware implementation, such as slots, magnetic tracks, and rails with one or more sensors or electrical contacts to facilitate detection and acceptance of a payment instrument. That is, the reader device 940 may include hardware implementations to enable the reader device 940 to interact with a payment instrument via a swipe (i.e., a card-present transaction where a customer slides a card having a magnetic strip through a payment reader that captures payment data contained in the magnetic strip), a dip (i.e., a card-present transaction where a customer inserts a card having an embedded microchip (i.e., chip) into a payment reader first until the payment reader prompts the customer to remove the card), or a tap (i.e., a card-present transaction where a customer may tap or hover his or her electronic device such as a smart phone running a payment application over a payment reader to complete a transaction via short-range communication) to obtain payment data associated with a customer. Additionally or optionally, the reader device 940 may also include a biometric sensor to receive and process biometric characteristics and process them as payment instruments, given that such biometric characteristics are registered with the payment service and coupled to (e.g., connected to) a financial account with a bank server.

The reader device 940 may include processing unit(s), computer-readable media, a reader chip, a transaction chip, a timer, a clock, a network interface, a power supply, and so on. The processing unit(s) of the reader device 940 may execute one or more components and/or processes to cause the reader device 940 to perform a variety of functions, as set forth above and explained in further detail in the following disclosure. In some examples, the processing unit(s) may include a central processing unit (CPU), a graphics processing unit (GPU), a CPU and a GPU, or processing units or components known in the art. Additionally, each of the processing unit(s) may possess its own local memory, which also may store program components, program data, and/or one or more operating systems. Depending on the exact configuration and type of the reader device 940, the computer-readable media may include volatile memory (such as RAM), non-volatile memory (such as ROM, flash memory, miniature hard drive, memory card, or the like), or some combination thereof. In at least one example, the computer-readable media of the reader device 940 may include at least one component for performing various functions as described herein.

The reader chip may perform functionalities to control the operations and processing of the reader device 940. That is, the reader chip may perform functionalities to control payment interfaces (e.g., a contactless interface, a contact interface, etc.), a wireless communication interface, a wired interface, a user interface (e.g., a signal condition device (FPGA)), etc. Additionally, the reader chip may perform functionality to control the timer, which may provide a timer signal indicating an amount of time that has lapsed following a particular event (e.g., an interaction, a power-down event, etc.). Moreover, the reader chip may perform functionality to control the clock, which may provide a clock signal indicating a time. Furthermore, the reader chip may perform functionality to control the network interface, which may interface with the network(s) 910, as described below.

Additionally, the reader chip may perform functionality to control the power supply. The power supply may include one or more power supplies such as a physical coupling to (e.g., connection to) AC power or a battery. Power supply may include power conversion circuitry for converting AC power and generating a plurality of DC voltages for use by components of reader device 940. When power supply includes a battery, the battery may be charged via a physical power coupling (e.g., connection), via inductive charging, or via any other suitable method.

The transaction chip may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. Additionally, the transaction chip may encrypt the payment data upon receiving the payment data.

The reader device 940 may be arranged to take payments in fiat currency, cryptocurrency or any other suitable media of payment. When a user uses a user device 920 coupled to (e.g., connected to) reader device 940 to make a payment, funds directly or indirectly deriving from the cryptocurrency mined by the mining stack 901 may be used for payment. Information relating to cryptocurrency mined and/or owned by the user of the user device 920 may be stored in the server and/or datastore(s) 930, or may be accessible from observation of a public ledger associated with the blockchain. This information about the user's cryptocurrency may then be used for such cryptocurrency based payments.

It should be understood that in some examples, the reader chip may have its own processing unit(s) and computer-readable media, and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While the user device 920, which can be a POS terminal, and the reader device 940 are shown as separate devices, in additional or alternative examples, the user device 920 and the reader device 940 can be part of a single device, which may be a battery-operated device. In such an example, components of both the user device 920 and the reader device 940 may be associated with the single device. In some examples, the reader device 940 can have a display integrated therewith, which can be in addition to (or as an alternative of) the display 925 associated with the user device 920.

The server(s) and/or datastore(s) 930 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

The server(s) and/or datastore(s) 930 may be coupled to (e.g., connected to) any one or more of the user device 920 and mining stack 901 via network(s) 910. The server(s) may store data relating the activity of any aspect of these components of the system 900, or interactions between one or more of these components of the system 900. For example, the server(s) and/or datastore(s) 930 may store data relating to cryptocurrency successfully mined. The server(s) may store account data associated with a user logged into the user device 920. Each of this functionality may be provided on a single server or spread across multiple servers.

Further, while the figures illustrate the components and data of the server(s) and/or datastore(s) 930 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) and/or datastore(s) 930 can be located together or separately, and organized, for example, as virtual servers, server banks and/or server farms. The described functionality can be provided by the servers of a single merchant or enterprise, or can be provided by the servers and/or services of multiple different customers or enterprises.

When the server(s) and/or datastore(s) 930 performs the function of a datastore it can be configured to store data that is accessible, manageable, and updatable. In some examples, the server(s) and/or datastore(s) 930 can be integrated with the user device 920 and/or the mining stack 901. In other examples, as shown in FIG. 9, the server(s) and/or datastore(s) 930 can be located remotely from or locally to the mining stack 901. The server(s) and/or datastore(s) 930 can include multiple databases and/or servers coupled (e.g., connected) locally and/or remotely via the network(s) 910.

In at least one example, the server(s) and/or datastore(s) 930 can store user profiles, which can include merchant profiles, customer profiles, miner profiles and so on.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, etc.

Miner profiles can store data relating to miners. For example, data relating to mining activity carried out may be stored. In addition, data relating to blocks on the blockchain successfully mined may be stored. If a miner is part of a mining pool then data relating to the pool, other members of the pool and other relevant data associated with the pool may be stored. In some implementations the datastore may store data on a private or public blockchain.

Furthermore, in at least one example, the server(s) and/or datastore(s) 930 can store inventory database(s) and/or catalog database(s). As described above, an inventory can store data associated with a quantity of each item that a merchant has available to the merchant. Furthermore, a catalog can store data associated with items that a merchant has available for acquisition. The server(s) and/or datastore(s) 930 can store additional or alternative types of data as described herein.

In the illustrated example, mining stack 901 can include one or more ASICS (associated with the chiplet architecture 100), as well as one or more central controllers, computer-readable media, one or more I/O devices, and one or more communication interfaces. The central controller(s) can comprise one or more processors configured to fetch and execute computer-readable instructions stored in the computer-readable media, which can program the processor(s) to perform functions for controlling the ASICs as well as communicating with other components in the system 900.

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they that may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

The foregoing is merely illustrative of the principles of this disclosure and various modifications may be made by those skilled in the art without departing from the scope of this disclosure. The above described arrangements are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the following clauses.

As a further example, variations of apparatus or process parameters (e.g., dimensions, configurations, components, process step order, etc.) may be made to further improve the provided structures, devices and methods, as shown and described herein. In any event, the structures and devices, as well as the associated methods, described herein have many applications. Therefore, the disclosed subject matter should not be limited to any single arrangement described herein, but rather should be construed in breadth and scope in accordance with the appended clauses.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present disclosure, and may be included in more than one example of the present disclosure. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS application, POS terminal, web applications, mobile applications, POS topologies, payment cards, computer networks, and environments.

A chiplet may be used interchangeably with an ASIC. A chiplet may be considered an integrated circuit comprising multiple semiconductor dies. For example, a chiplet may comprise multiple semiconductor dies formed together using 2.5D or 3D manufacturing techniques.

A hash die may be referred to as a processing element, processing die, processing chip, hash chip or hashing chip. A control die may be referred to as a control element, a control chip, a control device or a controller.

While the ASIC described herein is described for use in mining cryptocurrency, it will be appreciated that it could be used for any application specific processing. For example, the ASIC could also be used for artificial intelligence or machine learning processing.

Also disclosed is an Application Specific Integrated Circuit, ASIC, for mining cryptocurrency, the ASIC comprising: a plurality of hash dies arranged to perform application-specific processing. The ASIC may also comprise a control die arranged to control the plurality of hash dies. The control die may use a larger node size (e.g., be formed using a larger node) than the plurality of hash dies. The ASIC may also comprise one or more interconnectors electrically connecting the control die to the plurality of hash dies. The ASIC may also comprise an integrated circuit package enclosing the control die and the plurality of hash dies.

The one or more interconnectors may include at least one of: an interposer on which the plurality of hash dies and the control die are mounted and through which the plurality of hash dies are electrically coupled to the control die; or a plurality of interconnection elements on which the plurality of hash dies are mounted and through which the plurality of hash dies are electrically coupled to the control die.

The one or more interconnectors may comprise either: an interposer on which the plurality of hash dies and the control die are mounted and through which the plurality of hash dies are electrically connected to the control die; or a plurality of interconnection elements, wherein the plurality of hash dies are mounted on, and electrically connected to, the control die by the plurality of interconnection elements. The interposer may be active or passive.

The plurality of hash dies may include one or more sensor probes arranged to monitor one or more characteristics of the plurality of hash dies, wherein the one or more characteristics include at least one of a process, a voltage, or a temperature; the plurality of hash dies provide one or more sensor signals to the control die relating to the one or more characteristics monitored by the one or more sensor probes; and the control die includes measurement logic arranged to monitor the one or more characteristics based on the one or more sensor signals.

The plurality of hash dies may comprise one or more sensor probes arranged to monitor one or more characteristics of the plurality of hash dies including one or more of process, voltage and temperature. The plurality of hash dies may provide one or more sensor signals to the control die relating to the one or more characteristics monitored by the one or more sensor probes. The control die may comprise measurement logic arranged to monitor the one or more characteristics based on the one or more sensor signals.

Also disclosed is an Application Specific Integrated Circuit, ASIC, for application-specific circuitry (e.g., for performing application-specific processing), the ASIC comprising: one or more hash dies arranged to perform application-specific processing; and a control die that is arranged to control the one or more hash dies.

The control die may use a larger node size (e.g., be formed using a larger node) than the one or more hash dies.

The ASIC may further comprise one or more interconnectors electrically coupling (e.g., connecting) the control die and the one or more hash dies.

The one or more interconnectors may include or comprise an interposer on which the one or more hash dies and the control die are mounted and through which the plurality of hash dies may be electrically connected to the control die. For instance, the one or more hash dies and the control die may be mounted on the interposer, and the one or more hash dies may be electrically coupled to the control die through the one or more interconnectors.

The one or more hash dies and the control die may be mounted on a surface (e.g., a first surface) of the interposer.

The ASIC may further comprise at least one through silicon via (TSV) that passes through the interposer from a first point on the surface (e.g., the first surface) of the interposer to a second point on a second surface of the interposer, wherein the second point of the TSV is a connector configured to communicate with an external device, wherein the first point of the TSV is coupled to at least one of the one or more hash dies or the control die. Through silicon vias may be provided through the interposer to enable external connections from the one or more hash dies and/or the control die at a second surface of the interposer. The external connections may be one or more of power, ground, clock and signal connections.

The one or more hash dies and the control die may be physically coupled and communicatively coupled to the interposer via at least one interconnector of the one or more interconnectors, wherein the at least one interconnector includes at least one of a microbump or a hybrid bond. The one or more interconnectors may further comprise one or more microbumps or hybrid bonds, and the one or more hash dies and the control die may be physically and communicatively connected to the interposer via the one or more microbumps or hybrid bonds.

The one or more interconnectors may connect the one or more hash dies and the control die directly, physically, and electrically. The one or more interconnectors may directly connect, physically and/or electrically, the one or more hash dies to the control die.

The one or more interconnectors may include at least one of (e.g., may be) microbumbs or hybrid bonds.

The one or more hash dies may be mounted on a surface (e.g., a first surface) of the control die via the one or more interconnectors.

The ASIC may further comprise at least one through silicon via (TSV) that passes through the control die from a first point on the surface of the control die to a second point on a second surface of the control die, wherein the second point of the TSV is a connector configured to communicate with an external device, wherein the first point of the TSV is coupled to the one or more hash dies. Through silicon vias may be provided through the control die to enable external connections from the one or more hash dies at a second surface of the control die. The external connections may be one or more of power, ground, clock and signal connections.

The control die may include or comprise measurement logic arranged to monitor one or more characteristics of the one or more hash dies.

One or more sensor probes may be incorporated into the one or more hash dies, wherein the one or more sensor probes are arranged to sense the one or more characteristics. Sensor probes may be incorporated into the hash dies arranged to sense the one or more characteristics.

The one or more characteristics may include at least one of (one or more of) temperature and/or voltage. The control die may provides a clock signal to the one or more hash dies.

The ASIC may comprise a plurality of hash dies. The one or more hash dies may be a plurality of hash dies. The one or more hash dies may comprise a plurality of hash cores. The ASIC may further comprise an integrated circuit package enclosing the control die and the one or more hash dies. The integrated circuit package may also enclose one or more of the interposer and the one or more interconnectors. The one or more hash dies may be configured for mining a cryptocurrency.

Also disclosed is a hash board for mining cryptocurrency comprising one or more of: a plurality of ASICs; a circuit board on which the plurality of ASICs are mounted and via which the plurality of ASICs are electrically connected; and a controller arranged to control the plurality of ASICs, wherein the plurality of ASICs may comprise: one or more hash dies arranged to perform application-specific processing; and a control die that is arranged to control the one or more hash dies. The control die may be formed using a larger node than the one or more hash dies. The plurality of ASICs may be communicatively connected in series. Each ASIC may comprise a plurality of hash dies. The plurality of ASICs may be electrically connected between terminals of a voltage source in series.

Also disclosed is a method for application-specific processing, the method comprising: receiving, at a control die, data associated with a block for a distributed ledger, the data associated with one or more transactions; apportioning, using the control die, subsets of the plurality of mining calculations across different hash dies of a plurality of hash dies, wherein the plurality of mining calculations are associated with a hashing algorithm; sending one or more control signals from the control die to the plurality of hash dies using a plurality of interconnectors that couple the control die to the plurality of hash dies, wherein the one or more control signals include respective instructions for the plurality of hash dies for performing the plurality of mining calculations according to the apportioning; receiving, at the control die and from the plurality of hash dies, results of the plurality of mining calculations; and determining, by the control die, at least one output based on the results of the plurality of mining calculations.

What is claimed is:

1. An Application Specific Integrated Circuit (ASIC) for mining cryptocurrency, the ASIC comprising:
a plurality of hash dies arranged to perform application-specific processing;
a control die arranged to control the plurality of hash dies, wherein the control die uses a larger node size than the plurality of hash dies;
one or more interconnectors electrically that couple the control die to the plurality of hash dies; and
an integrated circuit package enclosing the control die and the plurality of hash dies.

2. The ASIC of claim 1, wherein the one or more interconnectors include at least one of:
an interposer on which the plurality of hash dies and the control die are mounted and through which the plurality of hash dies are electrically coupled to the control die; or
a plurality of interconnection elements on which the plurality of hash dies are mounted and through which the plurality of hash dies are electrically coupled to the control die.

3. The ASIC of claim 1, wherein
the plurality of hash dies include one or more sensor probes arranged to monitor one or more characteristics of the plurality of hash dies, wherein the one or more characteristics include at least one of a process, a voltage, or a temperature;
wherein the plurality of hash dies provide one or more sensor signals to the control die relating to the one or more characteristics monitored by the one or more sensor probes; and
wherein the control die includes measurement logic arranged to monitor the one or more characteristics based on the one or more sensor signals.

4. An Application Specific Integrated Circuit (ASIC) for application-specific circuitry, the ASIC comprising:
one or more hash dies arranged to perform application-specific processing; and
a control die that is arranged to control the one or more hash dies.

5. The ASIC of claim 4, wherein the control die uses a larger node size than the one or more hash dies.

6. The ASIC of claim 4, further comprising one or more interconnectors electrically coupling the control die and the one or more hash dies.

7. The ASIC of claim 6, wherein the one or more interconnectors include an interposer, wherein the one or more hash dies and the control die are mounted on the interposer, and wherein the one or more hash dies are electrically coupled to the control die through the one or more interconnectors.

8. The ASIC of claim 7, wherein the one or more hash dies and the control die are mounted on a surface of the interposer.

9. The ASIC of claim 8, further comprising at least one through silicon via (TSV) that passes through the interposer from a first point on the surface of the interposer to a second point on a second surface of the interposer, wherein the second point of the TSV is a connector configured to communicate with an external device, wherein the first point of the TSV is coupled to at least one of the one or more hash dies or the control die.

10. The ASIC of claim 7, wherein the one or more hash dies and the control die are physically coupled and communicatively coupled to the interposer via at least one interconnector of the one or more interconnectors, wherein the at least one interconnector includes at least one of a microbump or a hybrid bond.

11. The ASIC of claim 6, wherein the one or more interconnectors connect the one or more hash dies and the control die directly, physically, and electrically.

12. The ASIC of claim 11, wherein the one or more interconnectors include at least one of microbumps or hybrid bonds.

13. The ASIC of claim 11, wherein the one or more hash dies are mounted on a surface of the control die via the one or more interconnectors.

14. The ASIC of claim 13, further comprising at least one through silicon via (TSV) that passes through the control die from a first point on the surface of the control die to a second point on a second surface of the control die, wherein the second point of the TSV is a connector configured to communicate with an external device, wherein the first point of the TSV is coupled to the one or more hash dies.

15. The ASIC of claim 4, wherein the control die includes measurement logic arranged to monitor one or more characteristics of the one or more hash dies.

16. The ASIC of claim 15, wherein one or more sensor probes are incorporated into the one or more hash dies, wherein the one or more sensor probes are arranged to sense the one or more characteristics.

17. The ASIC of claim 15, wherein the one or more characteristics include at least one of temperature or voltage.

18. The ASIC of claim 4, wherein the one or more hash dies are a plurality of hash dies.

19. The ASIC of claim 4, wherein the one or more hash dies include a plurality of hash cores.

20. A hash board for mining cryptocurrency comprising:
a plurality of Application Specific Integrated Circuits (ASICs);
a circuit board, wherein the plurality of ASICs are mounted on the circuit board, wherein the plurality of ASICs are electrically coupled through the circuit board; and
a controller arranged to control the plurality of ASICs, wherein the plurality of ASICs includes:
one or more hash dies arranged to perform application-specific processing; and
a control die that is arranged to control the one or more hash dies.
